(19) United States
(12) Patent Application Publication
(10) Pub. No.: US 2012/0087154 A1
(43) Pub. Date: Apr. 12, 2012

(54) VOLTAGE SUPPLY DEVICE FOR A LOAD

(76) Inventors: Peter Maisel, Nurnberg (DE); Martin Saliternig, Herzogenaurach (DE)

(21) Appl. No.: 13/143,629

(22) PCT Filed: Dec. 16, 2009
(86) PCT No.: PCT/EP2009/067336

§ 371 Date: Dec. 16, 2011

(30) Foreign Application Priority Data
Jan. 9, 2009 (DE) 10 2009 004 225.3

(51) Int. Cl. H02H 11/00; H02M 3/335

(52) U.S. Cl. 363/19; 363/16; 363/21.18

(57) ABSTRACT

A voltage supply device for a load, in particular for a network, has an energy store that can be connected to connection terminals and a voltage transformer with at least one electronic switch. A reverse polarity protection is in contact with the connection terminals and is designed to convert voltage delivered from the energy store into control voltage for active activation of the electronic switch when the polarity of the voltage is reversed.

### CROSS-REFERENCE TO RELATED APPLICATIONS

This application is a U.S. National Stage Application of International Application No. PCT/EP2009/067336 filed Dec. 16, 2009, which designates the United States of America, and claims priority to German Application No. 10 2009 004 225.3 filed Jan. 9, 2009, the contents of which are hereby incorporated by reference in their entirety.

### TECHNICAL FIELD

The invention relates to a voltage supply device for a load, in particular for a power supply system, having an energy store and a voltage converter.

### BACKGROUND

In the case of battery back-up appliances, in particular for DC/DC converters for supplying a power supply system, which may be a motor vehicle on-board power supply system, a base station telecommunication device or the like, there is frequently a requirement for polarity reversal protection, with the aim of preventing incorrectly connected energy stores, such as batteries or rechargeable batteries, leading to damage to the downstream electronics. The risk of polarity reversal generally occurs during replacement, connection and disconnection of the energy store, unless mechanical protection measures are provided. If the energy store, which is in the form of a DC voltage source, is connected with the wrong polarity to the electrical or electronic circuit, a very high short-circuit current flows unless polarity reversal protection is provided. Since the electronic components are not designed for such high currents, this leads to destruction of the electronics.

In known DC/DC converters, for example for supplying a motor vehicle on-board power supply system, the terminals of the energy store, that is to say of the battery, are generally designed in such a way that it is possible to confuse the positive and negative connections. Circuitry measures according to the prior art are, for example, polarity reversal protection diodes, such as a diode in the load circuit, back-to-back parallel-connected Schottky diodes in the power path, series circuit breakers in the output path, series power diodes in the output path, or the like. For example, it is known for a diode to be connected in parallel with the terminals of the energy store, which diode absorbs the short-circuit current if the energy store polarity is reversed. Diodes such as these have to be able to carry a very high current, as a result of which they require a very large amount of space in the electronic appliance. The installation of a polarity reversal protection diode such as this also has a negative effect on the price of the appliance. If a diode is inserted in series, it admittedly has to carry only the load current, but this also results in a number of disadvantages at the same time such as reduction in the efficiency, bidirectional operation of the converter impossible, space requirements and, not least, the price of the appliance.

### SUMMARY

According to various embodiments, a voltage supply device for a load, in particular for a power supply system, such as a motor vehicle on-board power supply system, can be provided which ensures reliable polarity reversal protection, requires only a small amount of space and can be produced at relatively low cost.

According to an embodiment, a voltage supply device for a load, in particular for a power supply system, may have an energy store which can be connected to connecting terminals and having a voltage converter which comprises at least one electronic switch, characterized in that polarity reversal protection means are connected to the connecting terminals and are designed to convert the voltage supplied from the energy store to a control voltage for actively switching on the electronic switch if the polarity of the energy store is reversed.

According to a further embodiment, the polarity reversal protection means can be in the form of a polarity reversal protection voltage converter, whose connecting terminals are connected inverted to the voltage converter. According to a further embodiment, the voltage converter and/or the polarity reversal protection voltage converter can be in the form of DC/DC converters or a DC/DC converter(s). According to a further embodiment, a first protection diode can be connected between the negative connecting terminal of the voltage converter and the positive connection of the polarity reversal protection voltage converter in the input line to the polarity reversal protection voltage converter, and is activated only when the polarity of the energy store is reversed. According to a further embodiment, a second protection diode can be connected in the output line from the polarity reversal protection voltage converter, in order to prevent a reverse current from the voltage converter. According to a further embodiment, the at least one electronic switch of the voltage converter can be connected to a driver circuit, with the output voltage of the polarity reversal protection voltage converter controlling the driver circuit. According to a further embodiment, the output of the polarity reversal protection voltage converter can be connected to the control electrode of the at least one electronic switch in the voltage converter. According to a further embodiment, the polarity reversal protection voltage converter can be in the form of a flyback converter with PWM control or a free-running oscillator. According to a further embodiment, the flyback converter with PWM control may have a self-maintaining voltage supply. According to a further embodiment, the polarity reversal protection flyback converter can be in the form of a forward converter with a Meissner oscillator.

### BRIEF DESCRIPTION OF THE DRAWINGS

Exemplary embodiments will be explained in more detail in the following description and are illustrated in the drawing, in which:

FIG. 1 shows a block diagram of a voltage supply device according to the prior art with an energy store whose polarity has been reversed,

FIG. 2 shows a circuit refinement of a part of the voltage supply device,

FIG. 3 shows a detailed circuit refinement of a part of the voltage supply device, according to a first exemplary embodiment,

FIG. 4 shows a detailed circuit refinement of a part of the voltage supply device, according to a second exemplary embodiment,

FIG. 5 shows a circuit refinement of a first exemplary embodiment of the polarity reversal protection voltage converter,

FIG. 6 shows a circuit refinement of a second exemplary embodiment of the polarity reversal protection voltage converter, and

FIG. 7 shows a circuit refinement of a third exemplary embodiment of a polarity reversal protection voltage converter.

### DETAILED DESCRIPTION

Since the polarity reversal protection means, which are connected to the connecting terminals of the energy store, are designed to convert the voltage which is produced by the energy store if its polarity is reversed to a control voltage for actively switching on the electronic switch, the electronic components which are already used in the voltage converter circuit with synchronous, that is to say active, rectification can be used at least partially for protection of the electronics, in that the active semiconductors, that is to say the at least one electronic switch, are or is switched on in order to carry the short-circuit current. Actively switching on the electronic switches results in the short-circuit current no longer flowing via the parasitic diode when the electronic switches are in the form of MOSFETs, or via the external diode in the case of IGBTs, but via the open drain-source channel or the emitter-collector path. If the semiconductor switches are formed from a plurality of parallel-connected elements, the bridging of the internal or external diodes has a positive effect since the current distribution in the individual elements is not influenced by the thermally poorer diode characteristic (high temperature, lower forward-biased voltage, that is to say the most highly loaded diode is the best conductor). Actively switching on the switch likewise minimizes the losses in the components, and increases the rise and the amplitude of the short-circuit current. This results in the fuse in the overcurrent monitoring being reliably blown. Since the components are designed for high loads during normal operation, they can also carry the short-circuit current that occurs, without any additional cooling measures.

The polarity reversal protection means are advantageously in the form of a polarity reversal protection voltage converter which automatically becomes active when an energy store is connected with the wrong polarity, with energy being drawn from the energy store whose polarity is wrong.

In an exemplary embodiment, a first protection diode is arranged in the input line to the polarity reversal protection voltage converter and ensures that the polarity reversal protection voltage converter is activated only when an energy store is connected with the wrong polarity. This ensures that the additional measures have no influence on normal operation of the voltage converter.

In a correspondingly manner, a second protection diode is arranged in the output line from the polarity reversal protection voltage converter, in order to prevent a reverse current from the voltage converter, and this likewise contributes to safe operation during normal operation of the voltage supply device.

In an exemplary embodiment, the output voltage of the polarity reversal protection voltage converter is used to control the driver circuit for the electronic switches in the voltage converter.

Another exemplary embodiment provides for the output of the polarity reversal protection voltage converter to be connected to the control electrode of the at least one electronic switch in the voltage converter.

Depending on the field of use and the application, the voltage converter to the voltage supply device and/or the polarity reversal protection voltage converter may be in the form of isolating or non-isolating DC/DC converter.

The polarity reversal protection voltage converter is advantageously in the form of a flyback converter with PWM control or a free-running oscillator, in which case the embodiment with PWM control may be provided with a self-maintaining voltage supply, thus allowing an adequate output voltage still to be made available even when the input voltages become less.

In another exemplary embodiment, the polarity reversal protection flyback converter is in the form of a forward converter with a Meissner oscillator, which allows operation even at very low input voltages.

In summary, certain advantages can be stated to be that no additional power loss occurs during normal operation of the voltage converter, but the various embodiments can be used in many topologies, that a small number of additional components are required, and that a cost reduction and space reduction are possible.

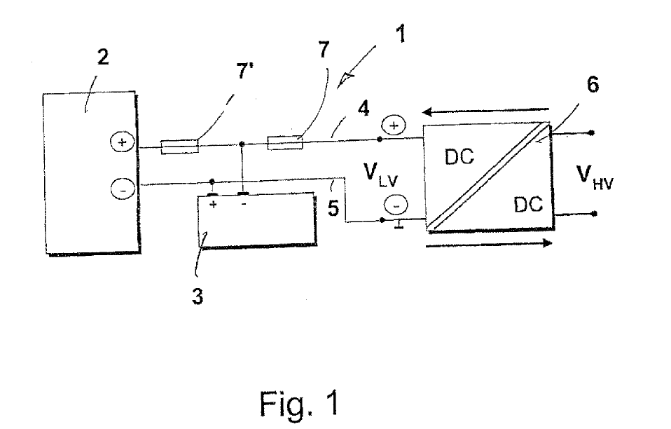

FIG. 1 shows a voltage supply device 1 for a load 2 which, for example, is in the form of a motor vehicle on-board power supply system. The voltage supply device has an energy store 3, for example a battery, whose connections have been connected in the wrong polarity to the positive and to the negative or ground line 4, 5. A DC/DC converter 6, which is used to step up a relatively low input voltage V_{LV} to a higher voltage V_{HV} and to step down the latter voltage to a voltage V_{LV} (indicated by the arrows in the figure), is correspondingly connected to the lines 4, 5. Furthermore, a fuse 7 for protection of the DC/DC converter 6 is connected in the positive line 4, facing the isolating converter 6, and a fuse 7′ for protection of the load is connected in the positive line 4, facing the load 2. Although a fuse is provided, a very high short-circuit current flows briefly in the event of polarity reversal, and could destroy the converter 6.

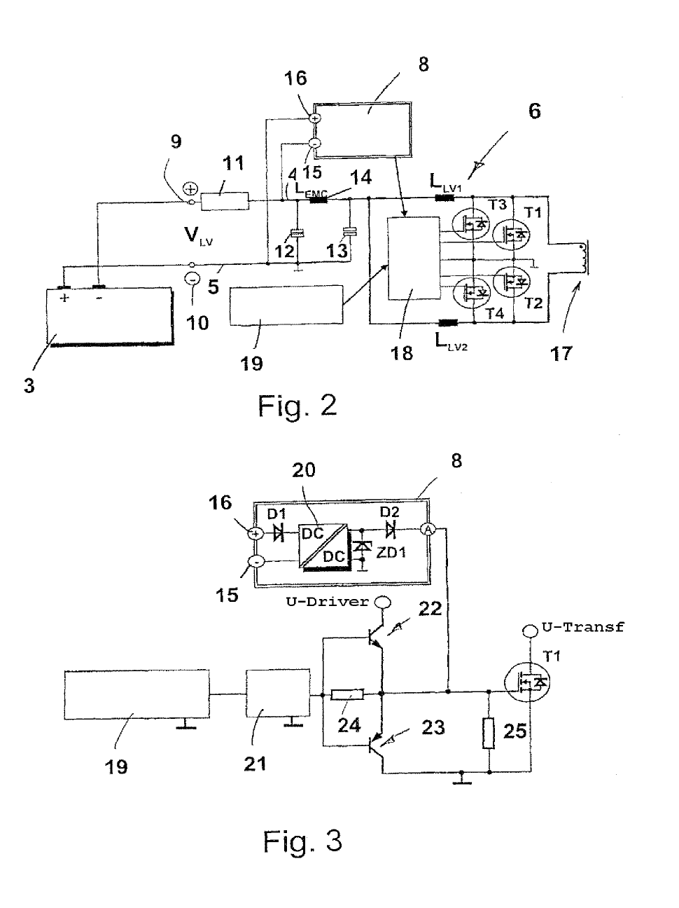

FIG. 2 illustrates the internal design of the isolating converter 6, partially in more detail, with a polarity reversal protection voltage converter 8 additionally being provided. The illustrated part of the voltage converter 6 is the low-voltage-side circuit of a current doubler topology. Other actively switched voltage converter topologies can, of course, be used, such as a full-wave bridge, half-wave rectification, rectification with a center tap, inverted rectification with a center tap, or the like. The circuit shown in FIG. 2 comprises the energy store 3, which is connected to the positive and negative terminals 9, 10 of the voltage converter 6 and is likewise illustrated with its polarity reversed in this case. The input of the voltage converter 6 is provided, via the fuse 7 which is not illustrated, with an EMC filter 11 for electromagnetic compatibility and two capacitors, an output capacitor 12 and a working capacitor 13, are connected between the positive line and ground, with a filter coil 14 being located in the positive line between these capacitors.

The polarity reversal protection voltage converter 8 is connected inverted to the converter 6 to be protected, that is to say the negative connection 15 of the polarity reversal protection voltage converter 8 is connected to the positive line 4, while the positive connection 16 is connected to the negative or ground line 5 of the converter 6.

As stated above, only the low-voltage side of the DC/DC converter 6 is illustrated, the high-voltage side is known per se and will not be explained in any more detail here. Two energy storage inductors L_{LV1} and L_{LV2} are connected to the positive line 4 at one connection of the working capacitor 13, and are connected to a winding of a transformer 17. In the present exemplary embodiment, four electronic switches T1, T2, T3, T4 are provided and are in the form of MOSFETs, with the drain connections being connected to the energy storage inductors L_{LV1}, L_{LV2} and to the transformer 17, and with the source connections being connected to ground. The gate electrodes are controlled by a gate driver 18, which is in turn controlled by a control unit 19, which may be in the form of a PWM controller, a microcomputer, or a CPLD (complex programmable logic device) microcontroller. Furthermore, the polarity reversal protection voltage converter 8 is connected to the gate driver 18. The method of operation of the DC/DC converter 6 is generally known, and will not be explained any further.

FIG. 3 illustrates the polarity reversal protection voltage converter 8 and the connection of the converter to a part of the gate driver 18 and to one of the electronic switches T1. The polarity reversal protection voltage converter 8 comprises a diode D1, which is connected to the positive connection 16, an isolating DC/DC converter 20, a zener diode ZD1 which stabilizes the output voltage, and a diode D2 which is connected to one output 8 of the polarity reversal protection voltage converter 8. The protection diode D1 is used at the input to activate the DC/DC converter 20 when the polarity of the energy store 3 is reversed, otherwise it blocks this. The diode D2 at the output prevents a reverse current from the gate driver 18. Only the connection of the polarity reversal protection voltage converter 8 to an electronic switch is shown here in which a plurality of diodes such as D2 may be required to prevent [inaudible] control electrodes from being directly connected to one another when there are a plurality of switches.

The driver, as illustrated in FIG. 3, for the electronic switch T1 comprises a logic circuit 21, which is connected on one side to the control unit 19 and on the other side to the base electrodes of in each case one transistor 22, 23. The emitters are connected to one another, and a resistor 24 which is connected between the base and the emitter sets the operating point. The driver voltage is applied to the collector of the transistor 22, and the collector of the transistor 23 is at ground potential. The emitter electrodes of the transistors 22, 23 are connected to the gate electrode of the MOSFET T1, with a resistor 25 between the gate electrode and ground keeping the control electrode in the switched-off state, even when no current is flowing through the electronics.

In the illustrated exemplary embodiment, the output A of the polarity reversal protection voltage converter 8 is connected to the gate electrode of the MOSFET T1. If the energy store 3 is connected with the polarity reversed, the diode D1 switches and activates the DC/DC converter 20, which in turn produces an output voltage which is stabilized by the zener diode ZD1, thus switching the transistor T1 and resulting in a voltage drop across the components 14, the inductors L_{LV1}, L_{LV2} and across the MOSFET T1, or the four MOSFETS T1 to T4. The fuse 7 is therefore reliably blown.

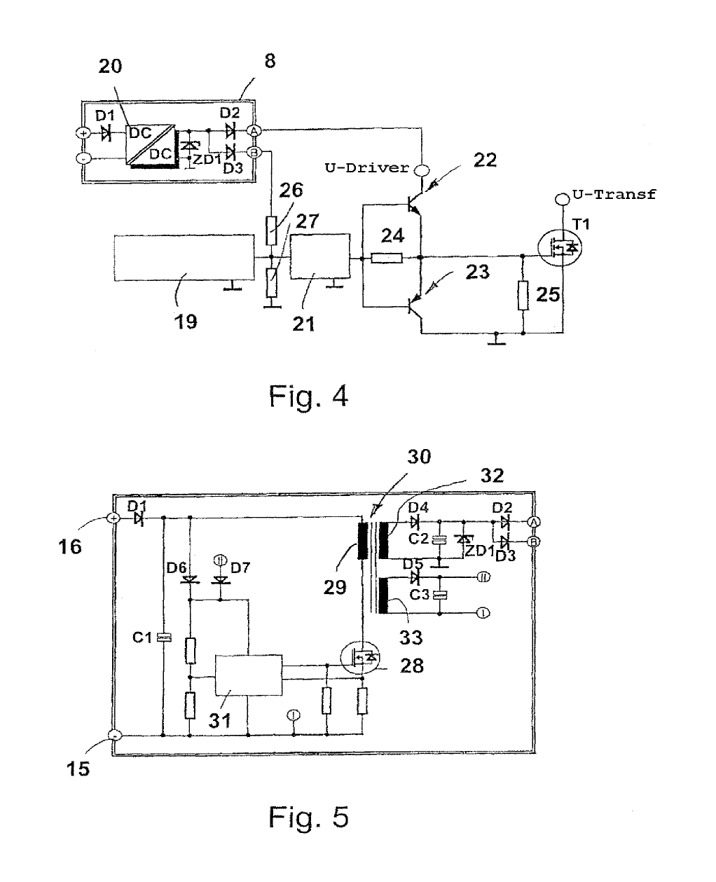

FIG. 4 illustrates a variant of FIG. 3, in which the output A of the polarity reversal protection voltage converter in this case supplies the driver voltage, and is connected to the collector of the transistor 22. In addition, a further output B is provided, with a diode T3 being connected between the output of the DC/DC converter 20 and the output B, which diode T3 is likewise used as a protection diode against reverse currents. The output B is connected to resistors 26, for matching to the driver input voltage. The other components correspond to those in FIG. 3. In the present case, the transistors 22, 23 are switched on when a voltage is produced at the outputs A and B of the polarity reversal protection voltage converter 8, in which case the MOSFET T1 is then switched.

FIGS. 5, 6 and 7 show various exemplary embodiments of the polarity reversal protection voltage converter 8, with FIG. 5 showing a flyback converter with a PWM controller. As shown in FIG. 5, the flyback converter has a switch 28, which is in the form of a MOSFET and is located with an energy storage inductor 29, which is a component of a transformer 30, between the positive and negative connections 15, 16 of the polarity reversal protection voltage converter 8. The switch 28 is controlled by a PWM controller 31, although the illustrated resistors will not be described in any more detail here, but are used to set the operating points and the switching thresholds.

When a voltage from the reversed-polarity energy store 3 is applied to the inputs 15, 16 of the voltage converter 8, the capacitor C1 is charged, and the PWM controller 31 is supplied with voltages, and switches the switch 28 to the switched-on and switched-off phase, corresponding to the control. In a corresponding manner, a current flows through the coil 29 of the transformer 30, and a magnetic field is built up. In the switched-on phase, the diodes D4 and D5 are reverse-biased, and no energy is transmitted. In the switched-off phase, the voltage across the windings 32, 33 is reversed, and a current flows via the diodes D4 and D5, charging the capacitors C2 and C3. In the switched-on phase, the capacitor C2 supplies the output voltage to switch the electronic switches T1 to T4 in the voltage converter 6, as described above.

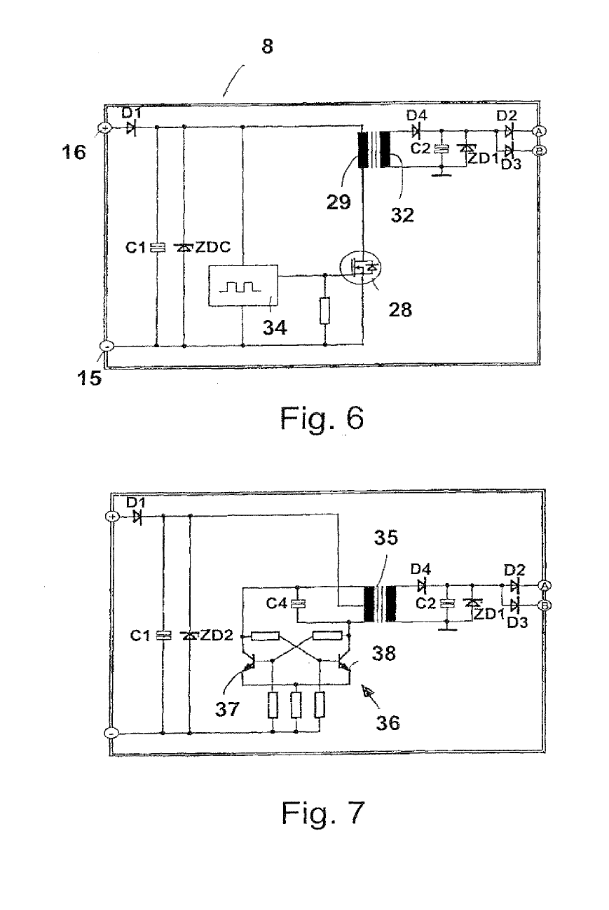

Since the input voltage to the polarity reversal protection voltage converter 8 decreases relatively quickly, operation must also be possible with small input voltages (0.1 V to 12 V), and an inverted or galvanically isolated output voltage of about 5 V to 15 V is produced. When the input voltage falls below a specific voltage value, for example below 2 V, the PWM controller 31 is supplied via the capacitor C3 on the secondary side of the transformer 30, as shown in the embodiment in FIG. 5, with the connections I, II of the capacitor, as can be seen from FIG. 5, being connected to a diode D7, which is connected to the PWM controller 31, and to the negative connection 15. The polarity reversal protection voltage converter 8 therefore maintains itself for a while. FIG. 6 shows a polarity reversal protection voltage converter 8 in the form of a flyback converter with a free-running oscillator 34, which controls the electronic switch 28. This flyback converter operates in a similar manner to that described above in conjunction with FIG. 5. The zener diode ZD2 is used as a protection diode against voltage spikes.

A further exemplary embodiment of a polarity reversal protection voltage converter 8 in the form of a forward converter with a Meissner oscillator is shown in FIG. 7. The output side of the voltage converter 8 is designed as shown in FIG. 6. The oscillator 36, which acts as a push-pull oscillator, in principle consists of two Meissner oscillators, with the components which govern the frequency being represented by the capacitor C4 and the coil 35. The transistors 37 and 38 are switched on alternately. The parallel-connected resistive voltage divider is used to set the base rest potential. This circuit as shown in FIG. 7 is distinguished by operating even at low voltages.

What is claimed is:

1. A voltage supply device for a load comprising an energy store which can be connected to connecting terminals and having a voltage converter which comprises at least one electronic switch, wherein polarity reversal protection means are connected to the connecting terminals and are designed to convert the voltage supplied from the energy store to a control voltage for actively switching on the electronic switch if the polarity of the energy store is reversed.

2. The voltage supply device according to claim 1, wherein the polarity reversal protection means are in the form of a polarity reversal protection voltage converter, whose connecting terminals are connected inverted to the voltage converter.

3. The voltage supply device according to claim 1, wherein at least one of the voltage converter and/or the polarity reversal protection voltage are in the form of DC/DC converters or a DC/DC converter(s).

4. The voltage supply device according to claim 1, wherein a first protection diode is connected between the negative connecting terminal of the voltage converter and the positive, connection of the polarity reversal protection voltage means in the input line to the polarity reversal protection voltage converter, and is activated only when the polarity of the energy store is reversed.

5. The voltage supply device according to claim 1, wherein a second protection diode is connected in the output line from the polarity reversal protection voltage means, in order to prevent a reverse current from the voltage converter.

6. The voltage supply device according to claim 1, wherein the at least one electronic switch of the voltage converter is connected to a driver circuit, with the output voltage of the polarity reversal protection voltage means controlling the driver circuit.

7. The voltage supply device according to claim 1, wherein the output of the polarity reversal protection voltage means is connected to the control electrode of the at least one electronic switch in the voltage converter.

8. The voltage supply device according to claim 1, wherein the polarity reversal protection voltage means is in the form of a flyback converter with PWM control or a free-running oscillator.

9. The voltage supply device according to claim 8, wherein the flyback converter with PWM control has a self-maintaining voltage supply.

10. The voltage supply device according to claim 1, wherein the polarity reversal protection flyback converter is in the form of a forward converter with a Meissner oscillator.

11. A voltage supply device for a power supply system, comprising
an energy store which can be connected to connecting terminals and having a voltage converter which comprises at least one electronic switch,
a polarity reversal protection converter connected to the connecting terminals and operable to convert the voltage supplied from the energy store to a control voltage for actively switching on the electronic switch if the polarity of the energy store is reversed.

12. The voltage supply device according to claim 11, wherein the polarity reversal protection converter comprises connecting terminals which are connected inverted to the voltage converter.

13. The voltage supply device according to claim 11, wherein at least one of the voltage converter and the polarity reversal protection voltage converter are in the form of DC/DC converters or a DC/DC converter(s).

14. The voltage supply device according to claim 11, wherein a first protection diode is connected between the negative connecting terminal of the voltage converter and the positive connection of the polarity reversal protection voltage converter in the input line to the polarity reversal protection voltage converter, and is activated only when the polarity of the energy store is reversed.

15. The voltage supply device according to claim 11, wherein a second protection diode is connected in the output line from the polarity reversal protection voltage converter, in order to prevent a reverse current from the voltage converter.

16. The voltage supply device according to claim 11, wherein the at least one electronic switch of the voltage converter is connected to a driver circuit, with the output voltage of the polarity reversal protection voltage converter controlling the driver circuit.

17. The voltage supply device according to claim 11, wherein the output of the polarity reversal protection voltage converter is connected to the control electrode of the at least one electronic switch in the voltage converter.

18. The voltage supply device according to claim 11, wherein the polarity reversal protection voltage converter is in the form of a flyback converter with PWM control or a free-running oscillator.

19. The voltage supply device according to claim 18, wherein the flyback converter with PWM control has a self-maintaining voltage supply.

20. The voltage supply device according to claim 11, wherein the polarity reversal protection flyback converter is in the form of a forward converter with a Meissner oscillator.
